(19) United States
(12) Patent Application Publication
(10) Pub. No.: US 2012/0006035 A1
(43) Pub. Date: Jan. 12, 2012

(54) TURBINE RIM CUTTER FOR AIR TURBINE STARTER

(75) Inventors: Jeffrey M. Makulec, Rockford, IL (US); Matthew Gorajski, Rockford, IL (US); Matthew Slayter, Rockford, IL (US)

(73) Assignee: Hamilton Sundstrand Corporation, Windsor Locks, CT (US)

(21) Appl. No.: 12/831,676

(22) Filed: Jul. 7, 2010

(51) Int. Cl. F02C 7/27; F02C 7/32

(52) U.S. Cl. 60/778; 60/39.091

(57) ABSTRACT

An air turbine starter includes an air turbine starter rotor rotatably located at a central axis. The rotor includes a plurality of aerodynamic surfaces extending from a platform. At least one cutting element is located in the air turbine starter such that travel of the rotor along the central axis during operation of the air turbine starter results in removal of the platform and aerodynamic surfaces from the rotor via contact between the at least one cutting element and the rotor.

### BACKGROUND OF THE INVENTION

The subject matter disclosed herein relates to an air turbine starter for a gas turbine engine. More specifically, the subject disclosure relates to a shut-off mechanism for an air turbine starter.

Aircraft engines, for example, gas turbines, are typically equipped with an air turbine starter (ATS) mounted on the engine accessory gearbox. The functional purpose of the ATS is to accelerate the engine up to a desired speed prior to ignition of the engine combustor and to continue assisting the engine start until the engine is capable of operating independently. The ATS is typically driven by pressurized air provided by an air source such as an auxiliary power unit, another operating engine, or an external air cart connected to the ATS. Pressurized air or gas fed into the ATS drives rotation of an ATS rotor causing rotation of a starter shaft. The starter shaft transmits this rotation to the drive shaft of the accessory gearbox. Rotation of the gearbox shaft drives rotation of a high pressure rotor of the engine which induces airflow into the engine and causes rotation of the engine high pressure rotor assembly. When the engine rotation reaches a desired speed, the ATS is turned off by stopping pressurized air flow.

In certain conditions, the ATS may experience operation at a turbine free run speed, in which the turbine rotor operates without a resistive load on the output shaft, causing the turbine to accelerate to high speed. Such conditions may include an engine start system failure or a momentary loss of pressure at the ATS inlet which causes premature disengagement of an internal clutch of the ATS. Operation at turbine free run speed leads to failure of ATS turbine bearings thus allowing axial travel of the ATS rotor. Without quickly halting rotation of the ATS rotor, the ATS rotor will catastrophically fail causing significant damage to the ATS.

### BRIEF DESCRIPTION OF THE INVENTION

According to one aspect of the invention, an air turbine starter includes an air turbine starter rotor rotatably located at a central axis. The rotor includes a plurality of aerodynamic surfaces extending from a platform. At least one cutting element is located in the air turbine starter such that travel of the rotor along the central axis during operation of the air turbine starter results in removal of the platform and aerodynamic surfaces from the rotor via contact between the at least one cutting element and the rotor.

According to another aspect of the invention, a method of stopping operation of an air turbine starter includes locating at least one cutting element in an air turbine starter proximate to an air turbine starter rotor. The rotor is rotatably located at a central axis and includes a plurality of aerodynamic surfaces secured to a platform. The at least one cutting element contacts the rotor as a result of travel of the rotor along the central axis during operation of the air turbine starter and cuts through the rotor via contact between the rotating rotor and the at least one cutting element thereby releasing the platform and the plurality of aerodynamic surfaces from the rotor.

### BRIEF DESCRIPTION OF THE DRAWINGS

FIG. 1 is a cross-sectional view of an embodiment of an air turbine starter;

FIG. 2 is a cross-sectional view of another embodiment of an air turbine starter;

FIG. 3 is a cross-sectional view of yet another embodiment of an air turbine starter; and

FIG. 4 is a cross-sectional view of still another embodiment of an air turbine starter.

The detailed description explains embodiments of the invention, together with advantages and features, by way of example with reference to the drawings.

### DETAILED DESCRIPTION OF THE INVENTION

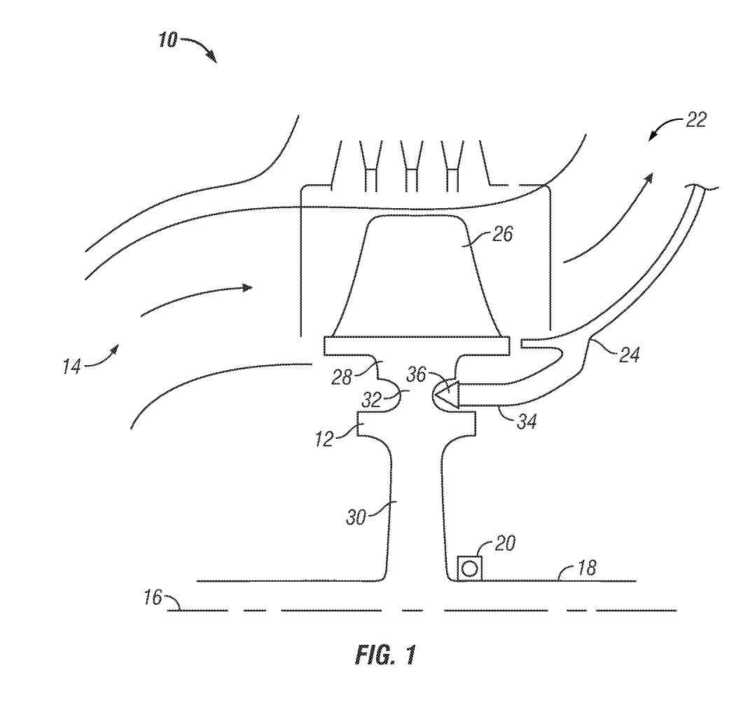

Shown in FIG. 1 is an embodiment of an air turbine starter (ATS) 10. The ATS 10 includes an ATS rotor 12 that is driven by a compressed gas, from a source such as an auxiliary power unit (APU), another operating engine, or an external air cart. The ATS 10 has a flow inlet 14, through which the compressed gas enters the ATS 10 and across the ATS rotor 12 thereby driving rotation of the ATS rotor 12 about a central axis 16. The ATS rotor 12 is operably connected to a gas turbine rotor (not shown) via a starter shaft 18. In some embodiments, the starter shaft 18 extends along the central axis 16. One or more bearings 20 located at the ATS rotor 12 position the ATS rotor 12 axially and radially in the ATS 10. A flow outlet 22 is located downstream of the ATS rotor 12 and provides exit for the flow of compressed gas from the ATS 10 after flowing across the ATS rotor 12. To direct the flow toward the flow outlet 22, some embodiments include an exhaust deflector 24.

The ATS rotor 12 includes a plurality of aerodynamic surfaces, for example, blades 26 located at a blade platform 28. The blades 26 and platform 28 are typically connected to a rotor disc 30 via a relatively thin-walled section, or web 32. The blades 26 may be shrouded or unshrouded. At least one cutting element 34 extends toward the web 32 from, for example, the exhaust deflector 24. The cutting element 34 includes a tip portion 36. The tip portion 36 may be triangular in shape as shown or may be another shape, for example, rectangular or partially spherical, depending on the shape of cut desired. In some embodiments, the tip portion 36 is formed integral to the cutting element 34, while in others the tip portion 36 is a separate element, such as a commercial machining tool insert affixed to the cutting element 34. The cutting element 34 and/or tip portion 36 can be formed from tungsten carbide or other suitable cutting material.

Under conditions where the ATS 10 operates at turbine free run speed, such as during an engine start system failure or premature disengagement of the clutch, operation at turbine free run speed leads to failure of the bearings 20, thus allowing axial travel of the ATS rotor 12 in the direction of the cutting element 34 due to the air pressure on the blades 26 and the rotor disc 30. When the ATS rotor 12 travels a sufficient distance, the stationary cutting element 34 engages the web 32 of the rotating ATS rotor 12 and proceeds to cut through the web 32 material and release the platform 28 and blades 26 from the ATS rotor 12. With the blades 26 released from the ATS rotor 12, rotation of the ATS rotor 12 stops, thus preventing further damage to the ATS 10.

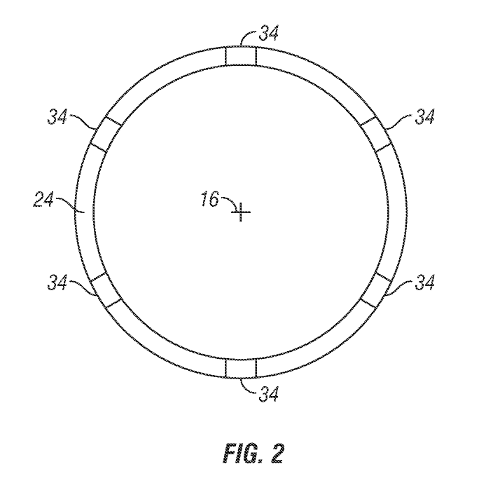

As shown in FIG. 2, in some embodiments, a number of cutting elements 34 are located around the ATS rotor 12. In the embodiment shown, the quantity of cutting elements 34 is six, but it is to be appreciated that other quantities of cutting elements 34, for example three, five or seven cutting elements 34 are contemplated within the scope of the present disclosure.

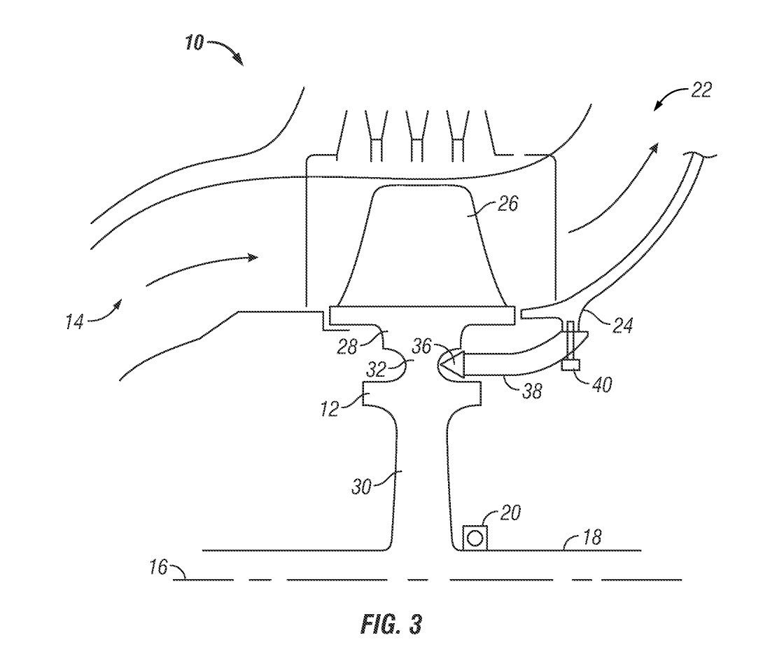

Referring now to FIG. 3, the cutting elements 34 may be disposed at a cutting ring 38, rather than directly at the exhaust deflector 24. The cutting ring 38 may be secured to the exhaust deflector 24 via, for example, mechanical fasteners such as bolts or screws 40 or, in some embodiments, the cutting ring 38 may be permanently affixed to the exhaust deflector 24 by, for example, welding. Alternatively, the cutting ring 38 may be secured to another component of the ATS 10.

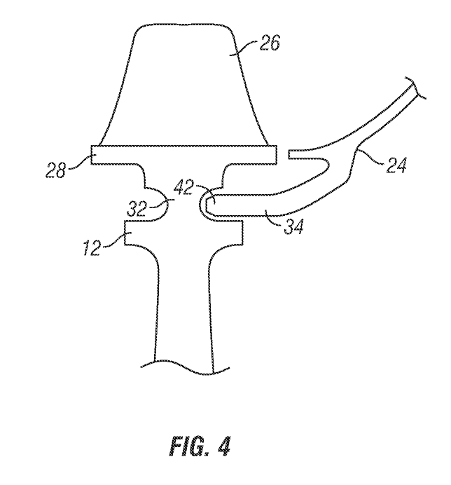

As shown in FIG. 4, alternate means may be utilized for removing the platform 28 and blades 26 from the ATS rotor 12. In some embodiments, the cutting element 34 has an abrasive surface 42, for example, a plasma-spray coating, applied thereto. Cutting of the web 32 to release the platform 28 and blades 26 is therefore accomplished via contact between the abrasive surface 42 and the rotating ATS rotor 12. Similar to the configurations described in FIGS. 2 and 3, the abrasive surface 42 can be applied to a number of cutting elements 34 or on cutting ring 38.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An air turbine starter comprising:
an air turbine starter rotor rotatably disposed at a central axis, the air turbine starter rotor including a plurality of aerodynamic surfaces extending from a platform;
at least one cutting element disposed in the air turbine starter such that travel of the air turbine starter rotor along the central axis during operation of the air turbine starter results in removal of the platform and aerodynamic surfaces from the air turbine starter rotor via contact between the at least one cutting element and the air turbine starter rotor.

2. The air turbine starter of claim 1, wherein the at least one cutting element extends from an exhaust deflector of the air turbine starter.

3. The air turbine starter of claim 2, wherein the at least one cutting element is secured to the exhaust deflector by bolts, screws, or other mechanical fasteners.

4. The air turbine starter of claim 2, wherein the at least one cutting element is inseparably affixed to the exhaust deflector.

5. The air turbine starter of claim 1, wherein the at least one cutting element comprises six cutting elements.

6. The air turbine starter of claim 1, wherein the at least one cutting element comprises at least one machining tool insert.

7. The air turbine starter of claim 6, wherein the at least one machining tool insert is formed from a tungsten alloy.

8. The air turbine starter of claim 1, wherein the at least one cutting element comprises an abrasive coating applied thereto.

9. The air turbine starter of claim 8, wherein the abrasive coating is a plasma spray coating.

10. A method of stopping operation of an air turbine starter comprising:
locating at least one cutting element in an air turbine starter proximate to an air turbine starter rotor rotatably disposed at a central axis, the air turbine starter rotor including a plurality of aerodynamic surfaces secured to a platform;
contacting the at least one cutting element to the air turbine starter rotor as a result of travel of the air turbine starter rotor along the central axis during operation of the air turbine starter; and
cutting through the air turbine starter rotor via contact between the rotating air turbine starter rotor and the at least one cutting element thereby releasing the platform and the plurality of aerodynamic surfaces from the air turbine starter rotor.

11. The method of claim 10 comprising stopping rotation of the air turbine starter rotor via release of the blades from the air turbine starter rotor.

12. The method of claim 10 comprising cutting through a web of the air turbine starter rotor.

13. The method of claim 10, wherein the at least one cutting element extends from an exhaust deflector of the air turbine starter.

14. The method of claim 13, wherein the at least one cutting element is secured to the exhaust deflector by bolts, screws, or other mechanical fasteners.

15. The method of claim 13, wherein the at least one cutting element is inseparably affixed to the exhaust deflector.

16. The method of claim 10, wherein the at least one cutting element comprises six cutting elements.

17. The method of claim 10, wherein the at least one cutting element comprises at least one machining tool insert.

18. The method of claim 10, wherein the at least one cutting element comprises an abrasive coating applied thereto.
